(19) United States
(12) Patent Application Publication
(10) Pub. No.: US 2019/0004409 A1
(43) Pub. Date: Jan. 3, 2019

(54) LIGHT SOURCE APPARATUS AND PROJECTION DISPLAY APPARATUS

(71) Applicant: Panasonic Intellectual Property Management Co., Ltd., Osaka (JP)

(72) Inventors: YUSAKU NISHIKAWA, Osaka (JP); MAKOTO MAEDA, Nara (JP)

(21) Appl. No.: 16/008,428

(22) Filed: Jun. 14, 2018

(30) Foreign Application Priority Data
Jun. 30, 2017 (JP) 2017-128356
Apr. 16, 2018 (JP) 2018-078091

(51) Int. Cl. G03B 21/20; G02B 27/14; G02B 27/28; G02B 5/20

(52) U.S. Cl. CPC G03B 21/2033; G03B 21/2066; G02B 5/20; G02B 27/28; G02B 27/141

(57) ABSTRACT

The light source apparatus includes a solid state light source, a phosphor plate, a dichroic mirror, a phase differential panel and an optical filter. The solid state light source emits excitation light of first linearly polarized light. The phosphor plate includes phosphor emitting fluorescence through light excitation. The dichroic mirror is disposed between the solid state light source and the phosphor plate, transmitting the excitation light of the first linearly polarized light, and reflecting the fluorescence as well as excitation light of second linearly polarized light. The phase differential panel is disposed between the dichroic mirror and the phosphor plate, and converting the excitation light of the first linearly polarized light to the excitation light of the second linearly polarized light. The optical filter transmits the fluorescence as well as reflects to guide the excitation light of the second linearly polarized light to the phosphor via the dichroic mirror.

### BACKGROUND

### 1. Technical Field

The present disclosure relates to a light source apparatus and a projection display apparatus.

### 2. Description of Related Art

A projector has employed a high-pressure mercury lamp as a light source; however, the high-pressure mercury lamp cannot be lit instantaneously or has a short service life. These drawbacks have required cumbersome maintenance jobs. On the other hand, solid state light sources (e.g. semiconductor laser, LED) have been developed recently, and use of those solid state light sources as light sources of image display apparatuses such as a projector is proposed (e.g. in patent literature 1 (Unexamined Japanese Patent Application Publication No. 2014-160227) and patent literature 2 (Unexamined Japanese Patent Application Publication No. 2012-98442)). Each of the projectors proposed in these literatures includes a laser light source and a light source apparatus that emits fluorescence excited by and emitted from the laser light source.

The light source apparatus disclosed in patent literature 1 includes a blue laser light source (semiconductor laser) serving also as an excitation light source, a phosphor wheel painted with segmented multiple phosphors, and a color wheel for trimming the fluorescence outgoing from the phosphor wheel into desirable light colors. This light source apparatus emits light colors in a time divisional manner.

The light source apparatus disclosed in patent literature 2 includes a blue laser light source (semiconductor laser) serving also as an excitation light source, a phosphor wheel painted with non-segmented phosphor. This light source apparatus emits the fluorescence together with a part of the excitation light source, thereby emitting white light.

### SUMMARY

The present disclosure aims to provide a light source apparatus and a projection display apparatus. These apparatuses employ a solid state light source for exciting phosphor to use fluorescence, and the light source apparatus as well as the projection display apparatus improves a fluorescence conversion efficiency, thereby obtaining light of greater illuminance.

The light source apparatus and the projection display apparatus of the present disclosure include a solid state light source, a phosphor plate, a dichroic mirror, a phase differential panel and an optical filter. The solid state light source emits excitation light of first linearly polarized light. The phosphor plate includes a substrate, a total reflection coating provided to the substrate, and phosphor formed on the total reflection coating and emitting fluorescence through light excitation. The dichroic mirror is disposed between the solid state light source and the phosphor plate, transmitting the excitation light of the first linearly polarized light, and reflecting the fluorescence as well as excitation light of second linearly polarized light orthogonal to the excitation light of the first linearly polarized light. The phase differential panel is disposed between the dichroic mirror and the phosphor plate, and converting the excitation light of the first linearly polarized light to the excitation light of the second linearly polarized light through a reciprocal transmission of the excitation light of the first linearly polarized light. The optical filter includes an optical filtering region transmitting the fluorescence reflected from the dichroic mirror as well as reflecting the excitation light of the second linearly polarized light reflected from the dichroic mirror to guide the excitation light of the second linearly polarized light to the phosphor via the dichroic mirror.

Use of the light source apparatus of the present disclosure allows achieving a light source apparatus and a projection display apparatus of greater illuminance.

### BRIEF DESCRIPTION OF DRAWINGS

FIG. 1 shows a structure of a projection display apparatus in accordance with a first embodiment of the present disclosure.

FIG. 2 shows a structure of a phosphor plate in accordance with the first embodiment.

FIG. 3 schematically illustrates a fluorescence conversion light path used in the first embodiment.

FIG. 4 shows a structure of a projection display apparatus in accordance with a second embodiment of the present disclosure.

FIG. 5 shows a structure of a phosphor plate in accordance with the second embodiment.

FIG. 6 shows a structure of a color filter wheel in accordance with the second embodiment.

### DETAILED DESCRIPTION

Exemplary embodiments of the present disclosure are detailed hereinafter with reference to the accompanying drawings. Descriptions more than necessary are sometimes omitted. For instance, well-known matters are not detailed, or duplicative descriptions about substantially the same structures are omitted. Because these omissions will help the descriptions below not be redundant, and aid the skilled persons in the art to understand the present disclosure with ease. The accompanying drawings and the descriptions below are provided for the skilled persons in the art to fully understand the present disclosure, and these materials will not limit the scope of the claims.

In the accompanying drawings, structural elements similar to each other have the same reference marks, and the drawings schematically illustrate the light source apparatus and the projection display apparatus in accordance with the embodiments, so that the ratios of each dimension differ from the actual ones. Actual dimensions should be determined based on the descriptions below. Not to mention, there are differences in relative dimensional relations or ratios between each dimension in some drawings.

In the embodiments below, a light source apparatus employed in a projection display apparatus is taken as an example; however, this projection display apparatus is not limited to an apparatus that employs the light source apparatus of the present disclosure. For instance, the apparatus may be a lighting apparatus such as a head lamp.

### First Exemplary Embodiment

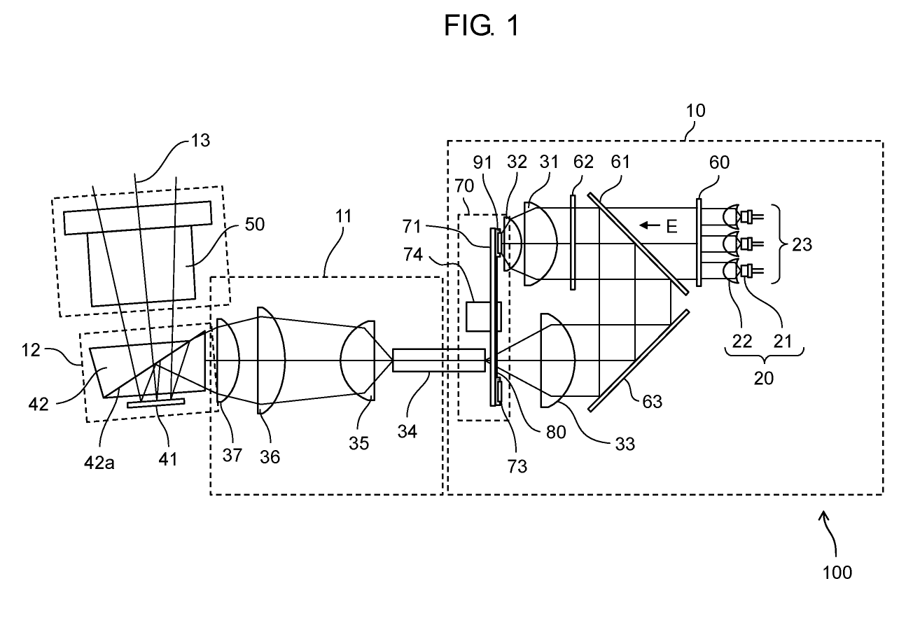

The projection display apparatus in accordance with the first embodiment is demonstrated hereinafter with reference to FIG. 1-FIG. 3.

### [Projection Display Apparatus]

FIG. 1 illustrates an optical structure, among others, of projection display apparatus 100 in accordance with the first embodiment. Projection display apparatus 100 employs one spatial modulating element, i.e. DMD (Digital Mirror Device) 41 for modulating light in response to an image signal.

As shown in FIG. 1, projection display apparatus 100 includes the following structural elements:
light source 20;
light source apparatus 10 formed of phosphor wheel 70 and optical filter 80;
lighting apparatus 11 casting an outgoing-beam from light source apparatus 10 to DMD 41 (i.e. spatial modulating element);
image display section 12, and
projecting section 13 projecting image-light (video) produced in image display section 12 onto a screen (not shown).
   Light source apparatus 10 emits reference illuminants of each color. Lighting apparatus 11 guides the reference illuminants of each color to image display section 12. The reference illuminant in this context refers to light color modulated by the spatial modulating element in response to an image signal.

The feature of projection display apparatus 100 in accordance with the present embodiment is that light source apparatus 10 includes the following structural elements: semiconductor laser 21, dichroic mirror 61, total reflection mirror 63, phase differential panel 62, phosphor 73, reflective coating 91, and optical filter 80. Semiconductor laser 21 is a laser light source for emitting the excitation light having characteristics of first linearly polarized light (e.g. P-polarized light). Dichroic mirror 61 transmits this P-polarized excitation light. On the other hand, dichroic mirror 61 reflects un-polarized fluorescence and excitation light having characteristics of second linearly polarized light (e.g. S-polarized light) orthogonal to the P-polarized light). Total reflection mirror 63 reflects the excitation light and the fluorescence. Phase differential panel 62 converts the P-polarized excitation light into circularly polarized light. Phosphor 73 is excited by laser beam (i.e. excitation light), thereby emitting fluorescence. Reflective coating 91 reflects the fluorescence and the excitation light. Optical filter 80 includes dichroic coating that trims a wavelength range of the fluorescence into a desirable range.

In this first embodiment, semiconductor laser 21 forms, together with collimator lens 22, light source 20, where collimator lens 22 roughly parallelizes the outgoing light from semiconductor laser 21. Semiconductor laser 21 is an example of a solid state light source.

In this first embodiment, light source 20 forms array light source 23, in which multiple light sources are arrayed in order to gain high-output reference illuminant. Light source 20 includes a forced-air-cooled heat sink (not shown) disposed behind thereof and working as a cooling system for light source 20.

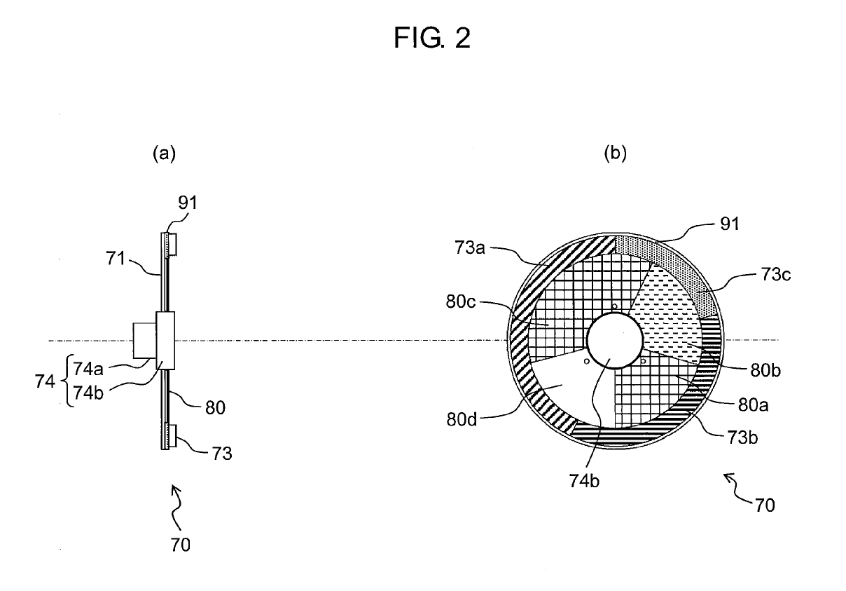

In this embodiment, phosphor 73, which emits fluorescence through the excitation by the laser beam, is disposed for instance in phosphor regions 73a, 73b on transparent substrate 71 of phosphor wheel 70 shown in FIG. 2.

In this embodiment, optical filter 80 is disposed inside the inner circumference of reflective coating 91 as shown in FIG. 2. This optical filter 80 reflects a part of the wavelength range of the fluorescence, and transmits a desirable wavelength range that will achieve a desirable light color. Optical filter 80 also reflects a wavelength range of unconverted excitation light for casting the light to the phosphor again.

### [Light Source Apparatus and Lighting Apparatus]

Light source 20 of light source apparatus 10 includes multiple semiconductor lasers 21 disposed such that lasers 21 emit P-polarized light, and collimator lenses 22 for condensing the outgoing light from each of semiconductor lasers 21 in roughly parallel manner. Collimator lenses 22 are provided to respective semiconductor lasers 21. In this embodiment, semiconductor lasers 21 employ blue laser beam (e.g. wavelength=455 nm) of which luminous efficiency is the highest among the three primary colors (i.e. R, G, B).

The outgoing light from light source 20 passes through diffuser 60, then passes through dichroic mirror 61 that is to transmit P-polarized excitation light (i.e. first linearly polarized light), and then the P-polarized light is converted by phase differential panel 62 to circularly polarized light. The excitation light converted to the circularly polarized light is condensed by a group of collimator lenses formed of lenses 31, 32 before being casted to phosphor 73 and reflective coating 91 formed on phosphor wheel 70. Diffuser 60 reduces interference caused by the light supplied from light source 20.

The blue light emitted from light source 20 is image light reflected on phosphor wheel 70 before forming an image of blue color, and at the same time, the blue light works as excitation light E for emitting fluorescence on phosphor wheel 70. Excitation light E enters phosphor 73 from light source 20, thereby emitting fluorescence F having a different wavelength band from that of excitation light E.

Both of excitation light E and fluorescence F emitting from phosphor wheel 70 are roughly parallelized by the group of collimator lenses formed of lens 31 and lens 32 before being casted again to phase differential panel 62. Since the fluorescence includes no polarization, phase differential panel 62 transmits the fluorescence without conversion of polarization. The fluorescence having no polarization is reflected on dichroic mirror 61 and total reflection mirror 63, then condensed by lens 33 before being casted to optical filter 80. The outgoing light from phosphor wheel 70 thus enters roughly perpendicularly to optical filter 80.

Excitation light E and fluorescence F, which is trimmed to a desirable light color by optical filter 80, outgo from optical filter 80, and then enter rod integrator 34. The light outgoes from rod integrator 34 is relayed through lens 35, lens 36, and lens 37, then outgoes from lighting apparatus 11 before entering image display section 12.

### [Phosphor Wheel]

The structure of phosphor wheel 70 is demonstrated with reference to FIG. 2. (a) of FIG. 2 is a lateral cross-section viewed along the same line as FIG. 1, and (b) of FIG. 2 is a front view of phosphor wheel 70 viewed from the right hand side of (a) of FIG. 2. As (a) of FIG. 2 shows, phosphor wheel 70 includes transparent substrate 71, annularly-shaped reflective coating 91 disposed on substrate 71, optical filter 80 disposed inside the inner circumference of reflective coating 91, phosphor 73 disposed on reflective coating 91, and motor 74. Motor 74 drives and rotates transparent substrate 71. Phosphor wheel 70 is an example of a phosphor plate, and transparent substrate 71 is an example of a substrate. Reflective coating 91 is an example of total reflection coating.

Transparent substrate 71 is mounted to driving section 74a of motor 74 via mounting section 74b, and its rotation is controlled by a controller (not shown). Mounting section 74b has a structure, for instance, of sandwiching transparent substrate 71 with a hub and a press member, and then fixing them with a screw.

Transparent substrate 71 is a transparent disc-shaped substrate, and formed of, for instance, sapphire substrate having high heat conductivity. Transparent substrate 71 includes, on its light-incident surface, annular phosphor F and annular reflective coating 91 that reflects excitation light E. As (b) of FIG. 2 shows, the surface of annular reflective coating 91 is divided into three regions (i.e. phosphor region 73a, phosphor region 73b, and light diffusion region 73c).

On phosphor region 73a, the phosphor emitting yellow fluorescence excited by blue light having a wavelength of approx. 455 nm is applied in a fan shape centered at the rotation center of transparent substrate 71. The yellow fluorescence has a chief wavelength of approx. 570 nm.

On phosphor region 73b, the phosphor emitting green fluorescence, of which chief wavelength is approx. 550 nm, is applied in a fan shape centered at the rotation center of transparent substrate 71. This phosphor region is excited by blue light having a chief wavelength of approx. 455 nm, thereby emitting the green fluorescence.

Phosphor region 73a is formed of yellow phosphor Py and transparent binder B, and phosphor region 73b is formed of green phosphor Pg and transparent binder B. Yellow phosphor Py includes, for instance, Y₃Al₅O₁₂:Ce₃⁺. Green phosphor Pg includes, for instance, Lu₃Al₅O₁₂:Ce₃⁺. Transparent binder B includes, for instance, silicone resin.

Light diffusion region 73c diffuses and reflects excitation light E casted thereto with no change in wavelength or polarization. In light diffusion region 73c, diffusion paint made of a mixture of transparent binder B and diffusion-reflection material is applied onto reflective coating 91 in a fan shape centered at the rotation center of transparent substrate 71.

The blue light (i.e. excitation light E) enters phosphor wheel 70 at the right-hand face in (a) of FIG. 2 and illuminates phosphor regions 73a, 73b, and light diffusion region 73c in response to the rotation of phosphor wheel 70.

Phosphor wheel 70 is to rotate the three regions discussed above (i.e. phosphor regions 73a, 73b, and light diffusion region 73c) as one frame (e.g. 1/60 second).

To be more specific, the light casted to phosphor wheel 70 sequentially illuminates, in a time equal to one frame, phosphor region 73a (first segment), phosphor region 73b (second segment), and light diffusion region 73c (third segment). In other words, the rotation speed of motor 74 is controlled such that phosphor wheel 70 completes a revolution in a time equal to one frame.

Excitation light E having entered phosphor regions 73a and 73b excites phosphors Py and Pg, thereby emitting yellow fluorescence Fy and green fluorescence Fg in isotropic manner. A component, emitting along the traveling direction of excitation light E, of yellow fluorescence Fy and green fluorescence Fg is totally reflected on reflective coating 91. Another component of phosphors Py and Pg emits oppositely to the traveling direction of excitation light E. These two components outgo together oppositely to the traveling direction of excitation light E. Excitation light E having entered light diffusion region 73c is diffused along an opposite direction to the traveling direction of excitation light E with no change in wavelength or polarization.

Excitation light E casted to the first and second segments of phosphor wheel 70 is converted into yellow fluorescence Fy and green fluorescence Fg. Excitation light E casted to the third segment outgoes in the opposite direction to the traveling direction of excitation light E with no change in wavelength or polarization, and is generally parallelized by lenses 32, 31 before passing through phase differential panel 62. This passing-through the panel 62 allows excitation light E diffused and reflected by a light diffusion surface of light diffusion region 73c to be converted from the circularly polarized light into S-polarized light (i.e. the second linearly polarized light) orthogonal to the incident excitation light E.

Unpolarized fluorescence F and S-polarized excitation light E, both having passed through phase differential panel 62, reflect from dichroic mirror 61, and are casted to optical filter 80 by total reflection mirror 63, which totally reflects excitation light E and fluorescence F, and lens 33.

### [Optical Filter]

The structure of optical filter 80 is described hereinafter with reference to FIG. 2. As (b) of FIG. 2 shows, optical filter 80 includes four segments: the first segment is optical filtering region 80a, and the third segment is optical filtering region 80c. These two segments are formed of a color filter that is highly transmissible in a visible range of wavelength=480 nm or greater, and highly reflective in a visible range of wavelength=480 nm or smaller. The second segment is optical filtering region 80b formed of a color filter highly transmissible in a visible range of wavelength=600 nm or greater and highly reflective in a visible range of wavelength=600 nm or smaller. The fourth segment is blue-light transmissible region 80d that includes a anti-reflection coating, and transmits excitation light E diffused by light diffusion region 73c. Each segment forms a fan shape centered at the rotation center of transparent substrate 71.

Light source apparatus 10 has an optical structure that guides a light beam such that yellow fluorescence Fy emitted from phosphor region 73a of phosphor wheel 70 can enter optical filtering regions 80a and 80b of optical filter 80.

The angle of phosphor region 73a is thus set to be equal to the sum of the angle of optical filtering region 80a and the angle of optical filtering region 80b. When yellow fluorescence Fy emitted from phosphor region 73a is to pass through optical filtering region 80a, visible light of wavelength=480 nm or smaller is reflected therefrom, and the visible light of wavelength=480 nm or greater passes through there, whereby yellow reference illuminant Ly is generated. When yellow fluorescence Fy emitted from phosphor region 73a is to pass through optical filtering region 80b, the visible light of wavelength=600 nm or smaller is reflected therefrom, and the visible light of wavelength=600 nm or greater passes through there, whereby red reference illuminant Lr is generated.

Light source apparatus 10 has an optical structure that guides a light beam such that green fluorescence Fg emitted from phosphor region 73b of phosphor wheel 70 enters optical filtering region 80c. The angle of phosphor region 73b is thus set to be equal to the angle of optical filtering region 80c. When green fluorescence Fg emitted from phosphor region 73b is to pass through optical filtering region 80c, visible light of wavelength=480 nm or smaller is reflected therefrom, and the visible light of wavelength=480 nm or greater passes through there, whereby green reference illuminant Lg is generated.

Light source apparatus 10 has an optical structure that guides a light beam such that excitation light E diffused and reflected by light diffusion region 73c of phosphor wheel 70 enters blue-light transmissible region 80d of optical filter 80. The angle of light diffusion region 73c is thus set to be equal to the angle of blue-light transmissible region 80d. Excitation light E reflected on light diffusion region 73c passes through blue-light transmissible region 80d, whereby blue reference illuminant Lb is generated.

### [Image Display Section and Projection System]

Image display section 12 receives the light casted from lighting apparatus 11, thereby generating an image, and as FIG. 1 shows, it is formed of total reflection prism 42 and one sheet of DMD 41 (i.e. spatial modulating element).

Total reflection prism 42 includes surface 42a that totally reflects light depending on an incident angle, and guides incident light from lighting apparatus 11 to DMD 41. DMD 41 includes multiple movable micro-mirrors that are controlled, by a controller (not shown), in accordance with the timings of incident reference illuminants of each color and also in response to image signals supplied. The light modulated by DMD 41 passes through total reflection prism 42, and is guided to projection lens 50 of projecting section 13.

An image composited timewise is projected onto the screen through projection lens 50 of projecting section 13.

### [Fluorescence Converting Light-Path]

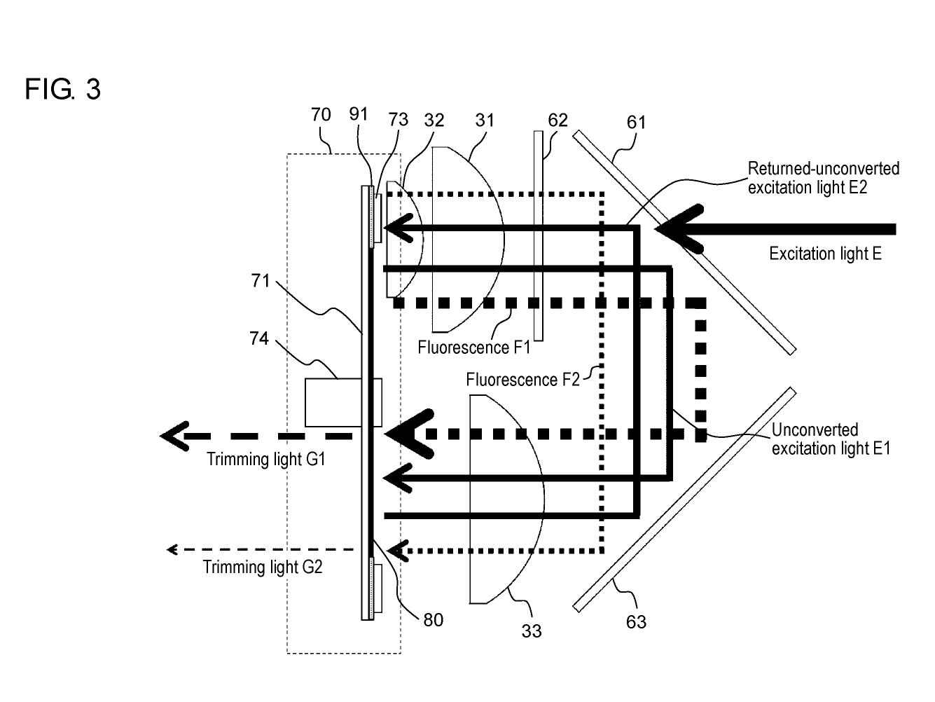

A fluorescence converting light-path of light source apparatus 11 is described hereinafter with reference to FIG. 3, which schematically shows an enlarged structure of a fluorescence converting section of light source apparatus 10 shown in FIG. 1, nevertheless, light source 20 is omitted in FIG. 3. The fluorescence converting section is chiefly formed of phosphor wheel 70, dichroic mirror 61, total reflection mirror 63, and phase differential panel 62.

Excitation light E having emitted from light source 20 (i.e. excitation light source) passes through dichroic mirror 61, phase differential panel 62, lens 31, and lens 32, and then enters phosphor 73 of phosphor wheel 70. A part of excitation light E having entered phosphor 73 is absorbed into phosphor 73, and some of this part turns into fluorescence F1 with a given fluorescence conversion rate before outgoing from phosphor 73. The remainder of this part is converted into heat. Excitation light E not absorbed into phosphor 73 remains as unconverted excitation light E1 and is reflected on reflective coating 91 of phosphor wheel 70.

Fluorescence F1 outgoing from phosphor 73 and unconverted excitation light E1 pass through lens 32, lens 31, and phase differential panel 62, and reflect from dichroic mirror 61 and total reflection mirror 63, then pass through lens 33 before entering optical filter 80.

Fluorescence F1 entered optical filter 80, where the light of certain wavelength band passes through optical filter 80 and the light of the other wavelength bands reflects from filter 80. Fluorescence F1 having undergone these processes then outgoes as trimming light G1 from optical filter 80.

Unconverted excitation light E1 having entered optical filter 80 reflects thereon, to become returned-unconverted excitation light E2, which then is guided to and enters phosphor 73 of phosphor wheel 70 with the aid of lens 33, total reflection mirror 63, dichroic mirror 61, phase differential panel 62, lens 31, and lens 32.

A part of the returned-unconverted excitation light E2 is absorbed into phosphor 73, and a part thereof turns to fluorescent F2 with a given fluorescence conversion rate. The remainder thereof is converted to heat.

Fluorescence F2 having emitted from phosphor 73 passes through lenses 32, 31, and phase differential panel 62, then reflects from dichroic mirror 61 and total reflection mirror 63, and passes through lens 33 before entering optical filter 80.

Fluorescence F2 entered optical filter 80, where the light of certain wavelength band passes through optical filter 80 and the light of the other wavelength bands reflects from filter 80. Fluorescence F2 having undergone these processes then outgoes as trimming light G2 from optical filter 80.

Then the outgoing light from phosphor wheel 70 enters optical filter 80 with the aid of the optical system formed of lenses 32, 31, phase differential panel 62, dichroic mirror 61, total reflection mirror 63, and lens 33. This optical system works conjugate with respect to the outgoing surface of phosphor wheel 70 and the incident surface of optical filter 80. As a result, unconverted excitation light E1 and returned-unconverted excitation light E2 travel through the light paths nearly equal to each other from the emittance from phosphor wheel 70 to the entrance again to phosphor wheel 70.

In this first embodiment, excitation light E having entered phosphor region 73a is converted to yellow fluorescence Fy as fluorescence F1, and when this yellow fluorescence Fy emitted from phosphor region 73a passes through optical filtering region 80a, yellow reference illuminant Ly is generated as trimming light G1. When this yellow fluorescence Fy passes through optical filtering region 80b, red reference illuminant Lr is generated as trimming light G1.

Unconverted excitation light E1 not absorbed into phosphor region 73a reflects from optical filtering regions 80a, 80b, and turns to returned-unconverted excitation light E2, then enters phosphor region 73a again. This returned-unconverted excitation light E2 is absorbed again into phosphor region 73a and is converted to yellow fluorescence Fy as fluorescence F2. When yellow fluorescence Fy emitted from phosphor region 73a passes through optical filtering region 80a, yellow reference illuminant Ly is generated as trimming light G2. When this yellow fluorescence Fy passes through optical filtering region 80b, red reference illuminant Lr is generated as trimming light G2.

Excitation light E having entered phosphor region 73b is converted to green fluorescence Fg as fluorescence F1, and when this green fluorescence Fg emitted from phosphor region 73b passes through optical filtering region 80c, green reference illuminant Lg is generated as trimming light G1. A part of excitation light E having entered phosphor region 73b is not absorbed therein, and this part of light E (i.e. unconverted excitation light E1), which reflects from optical filtering region 80c, then enters phosphor region 73b again, and is converted to green fluorescence Fg as fluorescence F2. When green fluorescence Fg emitted from phosphor region 73b passes through optical filtering region 80c, green reference illuminant Lg is generated as trimming light G2.

Excitation light E having reached to light diffusion region 73c reflects therefrom, and passes through blue-light transmissible region 80d, which is a light transmissible region of optical filter 80, to generate blue reference illuminant Lb.

A coating thickness and a density of phosphor 73 applied to phosphor wheel 70 are adjusted such that incident excitation light E can pass through phosphor 73 at a given percentage.

### [Advantage]

A light source apparatus, formed of a solid state light-emitting element, for obtaining reference illuminant through exciting a phosphor needs a high fluorescence conversion efficiency that converts the excitation light into the fluorescence. The mechanism of the phosphor to emit the fluorescence is this: the excitation light emitted from the solid state light-emitting element is casted to a phosphor layer formed on a phosphor plate through the optical system, and the phosphor (crystals or particles of the phosphor) dispersed in the phosphor layer absorbs the excitation light, whereby the fluorescence is generated and emitted in isotropic manner. To increase the fluorescence-conversion efficiency, there are two methods: one is an increment in a density of the phosphor layer, and another is an increment in a thickness of the phosphor layer. These two methods will increase an amount of the excitation light to be absorbed. Nevertheless, these two methods adversely invite an increment in a temperature of the phosphor layer, so that an excellent result cannot be expected.

To overcome the problem discussed above, light source apparatus 10 in accordance with this first embodiment includes optical filter 80 formed of regions (optical regions 80a-80c) coated with coatings that reflect the light having the wavelength of the excitation light, and yet, the optical system works conjugate with respect to phosphor 73 of phosphor wheel 70 and optical filter 80, so that the unconverted excitation light not absorbed in the phosphor layer of phosphor wheel 70 reflects from optical filter 80, whereby this unconverted excitation light can be guided to the phosphor layer again. As a result, a greater amount of excitation light can be converted to the fluorescence, so that the greater illuminance can be expected for the light source apparatus.

On top of that, the thickness of phosphor 73 can be reduced with no reduction in an absorbable amount of the excitation light.

### Second Exemplary Embodiment

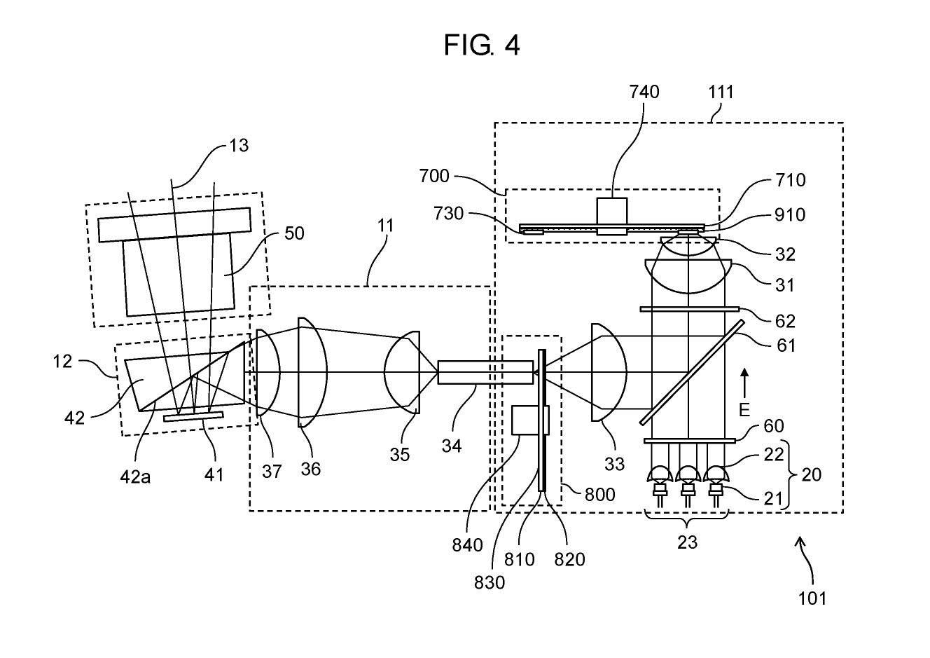

FIG. 4 shows a structure of projection display apparatus 101 in accordance with the second embodiment of the present disclosure. As FIG. 4 shows, projection display apparatus 101 includes light source apparatus 111, lighting apparatus 11, image display section 12, and projecting section 13. Lighting apparatus 11, image display section 12, and projecting section 13 stay the same as those of projection display apparatus 100 in accordance with the first embodiment. In the description below, structural elements similar to those shown in FIG. 1 have the same reference marks. Detailed and duplicated descriptions of those elements are omitted here. Different points from the first embodiment are chiefly described hereinafter.

Light source apparatus 10 in accordance with the first embodiment includes optical filter 80 on the rotary shaft side (i.e. between reflective coating 91 and motor 74). This structure is effective for downsizing the optical system. On the other hand, light source apparatus 111 in accordance with this second embodiment includes an optical structure formed of two wheels (i.e. phosphor wheel 700 and color filter wheel 800). An example of this two-wheel structure is demonstrated hereinafter.

### [Light Source Apparatus]

Light source apparatus 111 comprises the following structural elements:
light source 20 emitting excitation light E;
diffuser 60;
dichroic mirror 61 transmitting P-polarized excitation light E (i.e. first linearly polarized light) emitted from light source 20, and reflects S-polarized excitation light (i.e. second linearly polarized light orthogonal to the P-polarized light) as well as unpolarized fluorescence;
phase differential panel 62;
lenses 31, 32, 33;
phosphor wheel 700; and
color filter wheel 800.

The light emitted from light source 20 passes through diffuser 60, and passes through dichroic mirror 61 that transmits the P-polarized excitation light. Then phase differential panel 62 converts the P-polarized light to circularly polarized light. The excitation light converted to the circularly polarized light is condensed by lenses 31, 32 forming a collimator-lens group, and then is casted to phosphor 730 applied onto phosphor wheel 700.

Blue light emitted from light source 20 generates a blue image of image light, and also works as excitation light E that emits fluorescence with the aid of phosphor 730 applied on phosphor wheel 700. Phosphor 730 emits fluorescence F with the aid of excitation light E entering there from light source 20, where fluorescence F has a wavelength different from that of excitation light E.

Fluorescence F emitting from phosphor wheel 730 is generally parallelized by the collimator lens group formed of lenses 31, 32, and then is casted onto phase differential panel 62 again. Since fluorescence F has no polarized light, it passes through phase differential panel 62 with no conversion on polarized light. The fluorescence having no polarized light reflects from dichroic mirror 61, and is condensed by lens 33 before being casted to color filter wheel 800. As discussed above, the light emitted from phosphor wheel 700 enters roughly perpendicularly to color filter wheel 800. Both of excitation light E passing through color filter wheel 800 and fluorescence F trimmed into a desirable color by color filter wheel 800 outgo from color filter wheel 800, then enter rod integrator 34.

### [Phosphor Wheel and Fluorescence Converting Light-Path]

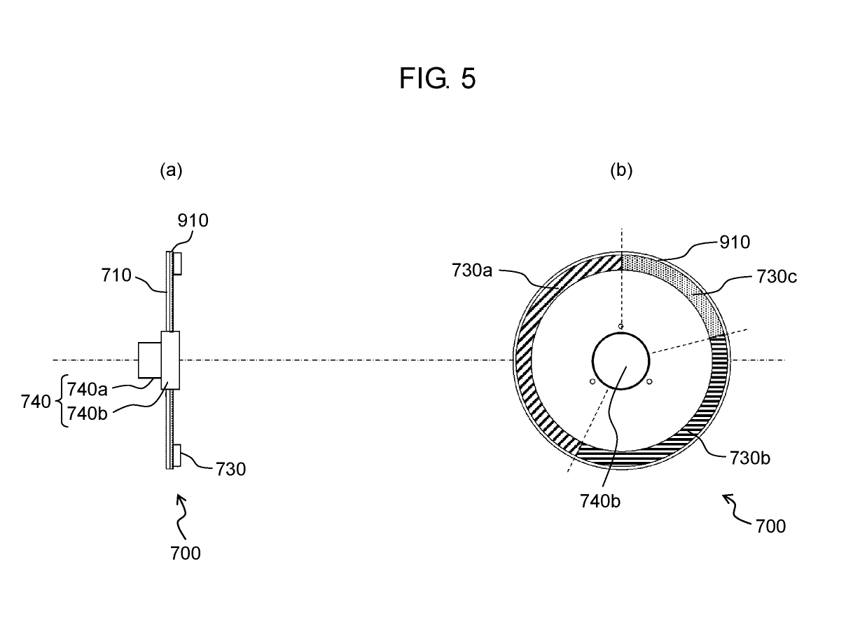

FIG. 5 shows a structure of phosphor wheel 700. (a) of FIG. 5 is a lateral cross section of phosphor wheel 700, and (b) of FIG. 5 is a front view of phosphor wheel 700 viewed from the right-hand side of (a) of FIG. 5.

Phosphor wheel 700 differs from phosphor wheel 70 in accordance with the first embodiment in the material for the substrate, which is not necessarily a transparent one in this second embodiment. Substrate 710 is shaped like a disc, and is made of, for instance, aluminum. Substrate 710 includes reflective annular coating 910 for reflecting fluorescence and excitation light on a light incident surface thereof. As (b) of FIG. 5 shows, the surface of annular reflective coating 910 is divided into three regions (i.e. phosphor regions 730a, 730b, and light diffusion region 730c). Phosphor wheel 700 is an example of the phosphor plate, substrate 710 is an example of the substrate, and the annular reflective coating is an example of the total reflection coating.

In phosphor region 730a, phosphor 730 is applied in a fan shape centered at the rotation center of substrate 710. This phosphor 730 emits yellow light, of which dominant wavelength is approx. 570 nm, by the excitation with the blue light having a wavelength of approx. 455 nm.

In phosphor region 730b, phosphor 730 is applied in a fan shape centered at the rotation center of substrate 710. This phosphor 730 emits green light, of which dominant wavelength is approx. 550 nm, by the excitation with the blue light having a wavelength of approx. 455 nm.

The phosphor coating provided to phosphor region 730a is formed of yellow phosphor Py and transparent binder B, while the phosphor coating provided to phosphor region 730b is formed of green phosphor Pg and transparent binder B. Yellow phosphor Py includes, for instance, Y₃A₁₅O₁₂:Ce₃⁺. Green phosphor Pg includes, for instance, Lu₃A₁₅O₁₂:Ce₃⁺. Transparent binder B includes, for instance, silicone resin.

No phosphor is applied to light diffusion region 730c, so that excitation light E casted thereto reflects totally therefrom with no change in wavelength or polarization. In light diffusion region 730c, diffusion paint formed of mixture of transparent binder B and diffusion-reflection material is applied in a fan shape centered at the rotation center of substrate 710.

The blue light (i.e. excitation light E) enters phosphor wheel 700 from the right-side surface of (a) of FIG. 5, and is casted to phosphor regions 730a, 730b, and light diffusion region 730c.

Phosphor wheel 700 is structured such that the three regions discussed above (i.e. phosphor region 730a, phosphor region 730b, and light diffusion region 730c) rotate at one frame (e.g. 1/60 second).

To be more specific, the light casted to phosphor wheel 700 time-divisionally and sequentially illuminates, in a time equal to one frame, phosphor region 730a (first segment), phosphor region 730b (second segment), and light diffusion region 730c (third segment). In other words, the rotation speed of motor 740 is controlled such that phosphor wheel 700 completes a revolution in a time equal to one frame. Substrate 710 is mounted to driving section 740a of motor 740 via mounting section 740b, and its rotation is controlled by a controller (not shown). Mounting section 740b has a structure, for instance, of sandwiching substrate 710 with a hub and a press member, and then fixing them with a screw.

Excitation light E having entered phosphor regions 730a and 730b excites phosphors Py and Pg, and whereby yellow fluorescence Fy and green fluorescence Fg are emitted in isotropic manner. A component, emitting along the traveling direction of excitation light E, of yellow fluorescence Fy and green fluorescence Fg emitted by the excitation is totally reflected from reflective coating 910. Another component of phosphors Py and Pg is emitted oppositely to the traveling direction of excitation light E. These two components outgo together oppositely to the traveling direction of excitation light E. Excitation light E having entered light diffusion region 73c is reflected in the opposite direction to the traveling direction of excitation light E with no change in wavelength or polarization.

Yellow fluorescence Fy, green fluorescence Fg, and excitation light E reflected from light diffusion region 730c are generally parallelized by lenses 32, 31 before passing through phase differential panel 62. At this time, excitation light E diffused and reflected by the light diffusion surface is converted from the circularly polarized light into S-polarized light (i.e. the second linearly polarized light) orthogonal to the incident excitation light E.

The fluorescence and excitation light E having passed through phase differential panel 62 reflect from dichroic mirror 61 at generally right angles, and are condensed by lens 33 before being casted to color filter wheel 800.

### [Color Filter Wheel]

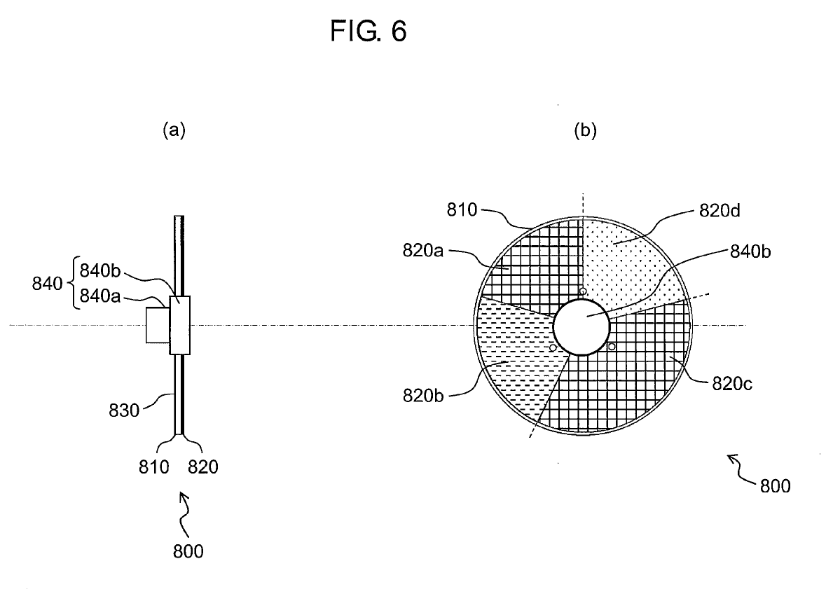

A structure of color filter wheel 800 is described hereinafter with reference to FIG. 6. (a) of FIG. 6 is a lateral cross-section of wheel 800 viewed along the same line as that in FIG. 4. (b) of FIG. 6 is a front view of wheel 800 viewed from the right-hand side of (a) of FIG. 6. As (a) of FIG. 6 shows, color filter wheel 800 includes transparent substrate 810, optical filter 820, anti-reflection coating 830, and motor 840.

Motor 840 drives and rotates disc-shaped transparent substrate 810, which is mounted to driving section 840a of motor 840 via mounting section 840b. The rotation of substrate 810 is controlled by a controller (not shown). Mounting section 840b, for instance, bonds transparent substrate 810 with the hub.

Transparent substrate 810 is a disc-shaped transparent substrate, and formed of glass substrate highly transmissible over entire visible range. The light incident-face of substrate 810 includes optical filter 820 coated with a dichroic coating that reflects a part of the incident light and transmits light having a desirable wavelength range that achieves a desirable light color. The light outgoing face of substrate 810 includes anti-reflection coating 830.

Optical filter 820 of color filter wheel 800 includes four segments as shown in (b) of FIG. 6. The first segment is optical filtering region 820a, and the third segment is optical filtering region 820c. These two segments are formed of color filter that is highly transmissible in a visible range of wavelength=480 nm or greater, and highly reflective in a visible range of wavelength=480 nm or smaller. The second segment is optical filtering region 820b formed of color filter highly transmissible in a visible range of wavelength=600 nm or greater and highly reflective in a visible range of wavelength=600 nm or smaller. The fourth segment is blue-light transmissible region 820d that has a light diffusion function for diffusing the incident light. Blue-light transmissible region 820d works as a diffusion panel formed of, for instance, a lens-array disposed on the surface of transparent substrate 810. Each one of the segments forms a fan shape centered at the rotation center of transparent substrate 810. Color filter wheel 800 is formed of one sheet of the transparent substrate on which multiple kinds of color filters and diffusion faces are formed locally (i.e. on the respective wheels) simultaneously, or it is formed integrally of fan-shaped filters arrayed with and fixed to the diffusion panel.

Phosphor wheel 700 and color filter wheel 800 are controlled such that they rotate at the same rpm synchronously. To be more specific, color filter 800 is controlled such that the four segments discussed above complete a revolution in a time equal to one frame (e.g. 1/60 second).

### [Timing for Phosphor Wheel and Color Filter Wheel]

The rotations of phosphor wheel 700 and color filter wheel 800 are controlled such that yellow fluorescence Fy emitting from phosphor region 730a of wheel 700 can enter optical filtering regions 820a and 820b of color filter wheel 800. The angle of phosphor region 730a is thus set to be equal to the sum of the angles of optical filtering regions 820a and 820b. When yellow fluorescence Fy emitted from fluorescence region 730a passes through optical filtering region 820a, the visible light of wavelength=480 nm or smaller reflects therefrom, and the visible light of wavelength=480 nm or greater passes through there, whereby yellow reference illuminant Ly is generated. When yellow fluorescence Fy emitted from phosphor region 730a passes through optical filtering region 820b, the visible light of wavelength=600 nm or smaller reflects therefrom, and the visible light of wavelength=600 nm or greater passes through there, whereby red reference illuminant Lr is generated.

The unconverted excitation light not absorbed in phosphor region 730a and not converted to yellow fluorescence Fy reflects from reflective coating 910 of phosphor wheel 700, and travels through lenses 32, 31, phase differential panel 62, dichroic mirror 61, and lens 33 before entering optical filtering regions 820a, 820b of color filter wheel 800. Since this unconverted excitation light has a wavelength of approx. 455 nm, it reflects from optical filtering regions 820a, 820b and returns to be unconverted excitation light, which then enters again phosphor region 730a, then this returned-unconverted excitation light is converted to yellow fluorescence Fy.

The rotation speeds of phosphor wheel 700 and color filter wheel 800 are controlled such that green fluorescence Fg emitted from phosphor region 730b can enter optical filtering region 820c of color filter wheel 800. The angle of phosphor region 730b is thus set to be equal to the angle of optical filtering region 820c. When green fluorescence Fg emitted from phosphor region 730b passes through optical filtering region 820c, visible light of wavelength=480 nm or smaller reflects therefrom, and the visible light of wavelength=480 nm or greater passes through there, whereby green reference illuminant Lg is generated.

The unconverted excitation light not absorbed into phosphor region 730b and not converted to green fluorescence Fg reflects from optical filtering region 820c and returns to be returned-unconverted excitation light, and it enters again phosphor region 730b, whereby green fluorescence Fg is emitted.

The rotation speeds of phosphor wheel 700 and color filter wheel 800 are controlled such that excitation light E reflected from optical diffusion region 730c can enter blue transmissible region 820d of color filter wheel 800. The angle of light diffusion region 730c is thus set to be equal to the angle of blue transmissible region 820d. Excitation light E passing through blue transmissible region 820d is diffused in region 820d and reflects therefrom, whereby blue reference illuminant Lb is generated.

### [Advantage]

The light emitting from phosphor wheel 700 is guided such that it can enter substantially perpendicularly to color filter wheel 800. This mechanism allows the unconverted excitation light reflected from phosphor wheel 700 to reflect from color filter wheel 800, and to be guided again to phosphor wheel 700. As a result, a greater amount of the excitation light can be converted to the fluorescence, thereby achieving the light source apparatus of greater illuminance.

### INDUSTRIAL APPLICABILITY

The present disclosure relates to a light source apparatus employing a phosphor-excitation light source, and is applicable to a projection display apparatus.

What is claimed is:

1. A light source apparatus comprising:
a solid state light source emitting excitation light of first linearly polarized light;
a phosphor plate including a substrate, a total reflection coating provided to the substrate, and phosphor formed on the total reflection coating and emitting fluorescence through light excitation;
a dichroic mirror disposed between the solid state light source and the phosphor plate, transmitting the excitation light of the first linearly polarized light, and reflecting the fluorescence as well as excitation light of second linearly polarized light orthogonal to the excitation light of the first linearly polarized light;
a phase differential panel disposed between the dichroic mirror and the phosphor plate, and converting the excitation light of the first linearly polarized light to the excitation light of the second linearly polarized light through a reciprocal transmission of the excitation light of the first linearly polarized light; and
an optical filter including an optical filtering region transmitting the fluorescence reflected from the dichroic mirror as well as reflecting the excitation light of the second linearly polarized light reflected from the dichroic mirror to guide the excitation light of the second linearly polarized light to the phosphor via the dichroic mirror.

2. The light source apparatus according to claim 1, further comprising:
a total reflection mirror guiding the excitation light of the second linearly polarized light reflected from the dichroic mirror and the fluorescence to the optical filter, and guiding the excitation light of the second linearly polarized light reflected from the optical filter to the dichroic mirror,
wherein the optical filter is disposed to the phosphor plate.

3. The light source apparatus according to claim 1, further comprising:
a color filter wheel receiving the fluorescence and the excitation light of the second linearly polarized light,
wherein the optical filter is disposed to the color filter wheel.

4. The light source apparatus according to claim 1, wherein the optical filter is divided into four regions including the optical filtering region transmitting the fluorescence and reflecting the excitation light of the second linearly polarized light.

5. The light source apparatus according to claim 1, wherein light outgoing from the phosphor plate enters substantially perpendicularly to the optical filter.

6. A projection display apparatus comprising the light source apparatus as defined in claim 1.
